(19) United States
(12) Patent Application Publication
(10) Pub. No.: US 2023/0065207 A1
(43) Pub. Date: Mar. 2, 2023

(54) USER QUALITY OF EXPERIENCE ASSESSMENT IN RADIO ACCESS NETWORKS

(71) Applicant: AT&T Intellectual Property I, L.P., Atlanta, GA (US)

(72) Inventors: Huahui Wang, Bridgewater, NJ (US); Wenjie Zhao, Princeton, NJ (US); Ravi Raina, Skillman, NJ (US)

(21) Appl. No.: 17/411,136

(22) Filed: Aug. 25, 2021

(51) Int. Cl. H04W 24/08; H04L 12/26; H04W 28/24; H04L 12/24

(52) U.S. Cl. CPC H04W 24/08; H04L 43/08; H04W 28/24; H04L 41/5067

(57) ABSTRACT

User quality of experience assessment in radio access networks is provided herein. A method can include measuring an average packet size of incoming data packets received via a radio access network, the incoming data packets respectively comprising data directed to respective network equipment served via the radio access network; determining service metrics for outgoing data packets transmitted via the radio access network to the respective network equipment in response to the incoming data packets being received via the radio access network, wherein the service metrics comprise an average transmission delay for the outgoing data packets and a packet loss rate for the outgoing data packets; and determining a quality of experience value associated with a performance of the radio access network based on a function of the average packet size of the incoming data packets and the service metrics for the outgoing data packets.

### TECHNICAL FIELD

The present disclosure relates to communication networks, and, in particular, to techniques for assessing quality of experience associated with a radio access network.

### BACKGROUND

Current wireless communication networks, such as Long Term Evolution (LTE) or 5G networks, can be implemented as Internet Protocol (IP) networks, in which standard communication protocols (e.g., Transmission Control Protocol/Internet Protocol (TCP/IP), etc.) can be used to send and receive data in packets. By doing so, an IP network can be given the capability to process a wide range of services and/or applications, from traditional file downloads and web surfing to emerging applications such as gaming, video streaming, and Internet of Things (IoT) device communications. As wireless communication systems continue to expand in functionality, it is desirable to implement techniques for assessing network performance across a variety of services and applications.

### DESCRIPTION OF DRAWINGS

FIG. 1 is a block diagram of a system that facilitates user quality of experience assessment in radio access networks in accordance with various aspects described herein.

FIG. 2 is a block diagram that depicts example functionality of the quality evaluation device of FIG. 1 in accordance with various aspects described herein.

FIGS. 3-4 are diagrams of respective network abstractions that can be performed in accordance with various aspects described herein.

FIG. 5 is a block diagram of a system for assessing quality of experience associated with a communication network in accordance with various aspects described herein.

FIG. 6 is a flow diagram of a method that facilitates computing packet delay associated with a radio access network in accordance with various aspects described herein.

FIG. 7 is a block diagram of a system that facilitates user quality of experience assessment for select devices served via a radio access network in accordance with various aspects described herein.

FIG. 8 is a block diagram of a system that facilitates performance assessment for a service added to a radio access network in accordance with various aspects described herein.

FIGS. 9-10 are diagrams depicting correlations between user quality of experience and user throughput for an example radio access network in accordance with various aspects described herein.

FIG. 11 is a flow diagram of a method that facilitates user quality of experience assessment in radio access networks in accordance with various aspects described herein.

FIG. 12 depicts an example computing environment in which various embodiments described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring certain aspects.

In an aspect, a method as described herein can include measuring, by a system including a processor, an average packet size of incoming data packets received via a radio access network. The incoming data packets can respectively include data directed to respective network equipment served via the radio access network. The method can further include determining, by the system, service metrics for outgoing data packets transmitted via the radio access network to the respective network equipment in response to the incoming data packets being received via the radio access network. The service metrics can include an average transmission delay for the outgoing data packets and a packet loss rate for the outgoing data packets. The method can additionally include determining, by the system, a quality of experience value associated with a performance of the radio access network based on a function of the average packet size of the incoming data packets and the service metrics for the outgoing data packets.

In another aspect, a system as described herein can include a processor and a memory that stores executable instructions that, when executed by the processor, facilitate performance of operations. The operations can include determining an average packet size for incoming data packets received via a radio access network, where the incoming data packets respectively include data directed to network devices served via the radio access network. The operations can also include determining service quality metrics for outgoing data packets, transmitted via the radio access network to the respective network equipment in response to reception of the incoming data packets via the radio access network, the service quality metrics including an average transmission delay for the outgoing data packets and a packet loss rate for the outgoing data packets. The operations can further include assigning a quality of experience score, indicative of a performance of the radio access network, to the radio access network based on a function of the average packet size for the incoming data packets and the service quality metrics for the outgoing data packets.

In a further aspect, a non-transitory machine-readable medium as described herein can include executable instructions that, when executed by a processor, facilitate performance of operations. The operations can include measuring an average size of incoming data packets, received via a radio access network and including data directed to network equipment served via the radio access network; determining service quality metrics for outgoing data packets, transmitted via the radio access network to the respective network equipment in response to the radio access network receiving the incoming data packets, where the service quality metrics include an average transmission delay of the outgoing data packets and a packet loss rate for the outgoing data packets; and quantifying a performance of the radio access network based on a function of the average size of the incoming data packets and the service quality metrics for the outgoing data packets.

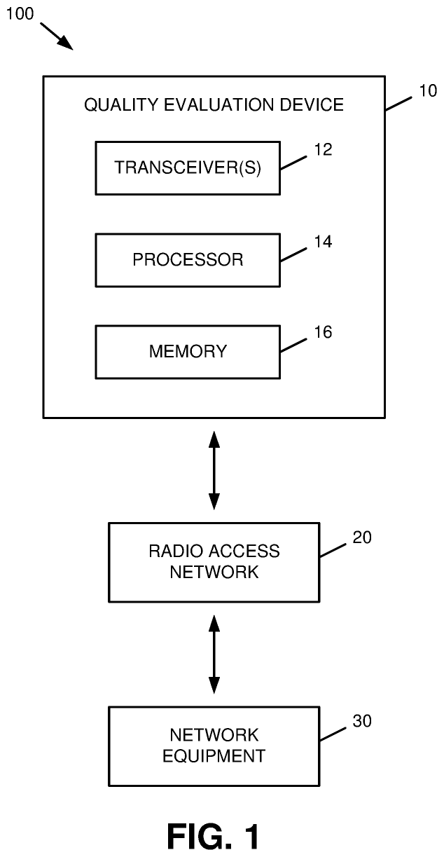

Referring first to FIG. 1, a system 100 that facilitates user quality of experience assessment in radio access networks is illustrated. System 100 as shown by FIG. 1 includes a quality evaluation device 10 that can evaluate the performance of an associated radio access network (RAN) 20 as described in further detail below. The RAN 20 can, in turn, communicate with associated network equipment 30. In an aspect, the quality evaluation device 10, the RAN 20, and the network equipment 30 can form at least a portion of a wireless communication network. While only one quality evaluation device 10 and one network equipment 30 are illustrated in FIG. 1 for simplicity of illustration, it is noted that a wireless communication network can include any amount of quality evaluation devices 10, network equipment 30, and/or other devices.

The RAN 20 shown in system 100 can include one or more elements, such as an eNodeB (eNB), gNodeB (gNB), or other network access point, controller devices, and/or any other device(s) that can provide network communication functionality to associated network equipment 30 in an area associated with the RAN 20. While not shown in system 100, the RAN 20 can also connect to a core network, and/or other networks, to facilitate communication between various devices of the network equipment 30, such as devices served via different RANs 20 of a same network provider or of different network providers. While the RAN 20 is illustrated in FIG. 1 as distinct from its associated network equipment 30, various RAN elements, such as an access point or the like, could also operate as, or include the functionality of, the network equipment 30 in some implementations.

In an aspect, the network equipment 30 shown in system 100 can include any suitable device(s) that can communicate over a wireless communication network associated with the quality evaluation device 10. Such devices can include, but are not limited to, cellular phones, computing devices such as tablet or laptop computers, autonomous vehicles, Internet of Things (IoT) devices, etc. Also or alternatively, the network equipment 30 could include a device such as a modem, a mobile hotspot, or the like, that provides network connectivity to another device (e.g., a laptop or desktop computer, etc.), which itself can be fixed or mobile. In an aspect, the network equipment 30 shown in system 100 can be provided access to the communication network via the RAN 20, e.g., such that the network equipment can be served by one or more elements of the RAN 20, or via the RAN 20 collectively, as described above.

The quality evaluation device 10 shown in system 100 can be implemented via an access point and/or one or more other elements of the RAN 20, or by one or more devices that communicate with elements of the RAN 20, such as an Element Management System (EMS) or the like. Alternatively, the quality evaluation device 10 be implemented via a server or other computing device that can communicate with elements of the RAN 20 and/or other networks, such as a core network that is connected to the RAN 20, via one or more networks or internetworks. By way of specific, non-limiting example, the quality evaluation device 10 could be implemented in this manner via a cloud application or service that communicates with network elements associated with the RAN 20 and/or the network equipment 30 via the Internet.

While the quality evaluation device 10 is shown in FIG. 1 as a single device, it is noted that the functionality of the quality evaluation device 10 as described herein could be distributed among multiple distinct devices that can communicate with each other over the wireless communication network and/or by other means, such as a backhaul link that facilitates direct communication between respective network elements. Other implementations could also be used.

The quality evaluation device 10 shown in system 100 can include one or more transceivers 12 that can communicate with (e.g., transmit messages to and/or receive messages from) the RAN 20, the network equipment 30, and/or other devices in system 100. The transceiver 12 can include respective antennas and/or any other hardware or software components (e.g., an encoder/decoder, modulator/demodulator, etc.) that can be utilized to process signals for transmission and/or reception by the quality evaluation device 10 and/or associated network devices.

In an aspect, the quality evaluation device 10 can further include a processor 14 and a memory 16, which can be utilized to facilitate various functions of the quality evaluation device 10. For instance, the memory 16 can include a non-transitory computer readable medium that contains computer executable instructions, and the processor 14 can execute instructions stored by the memory 16. For simplicity of explanation, various actions that can be performed via the processor 14 and the memory 16 of the quality evaluation device 10 are shown and described below with respect to various logical components. In an aspect, the components described herein can be implemented in hardware, software, and/or a combination of hardware and software. For instance, a logical component as described herein can be implemented via instructions stored on the memory 16 and executed by the processor 14. Other implementations of various logical components could also be used, as will be described in further detail where applicable.

In an aspect, the processor 14 and the memory 16 of the quality evaluation device 10 can facilitate assessment of user quality of experience (QoE) directly from elements of the RAN 20. The quality evaluation device 10 can generate and utilize metrics that can be utilized to provide meaningful quality evaluation for all applications without regard to application payload size or other properties. The functionality of the quality evaluation device 10 as described herein can be of particular benefit to applications utilized by Internet of Things (IoT) devices, for which existing measures such as user throughput are less reliable due to small payload size. While various implementations described herein are specific to LTE and/or 5G network environments, it is noted that the quality evaluation device 10 as described herein can function in any suitable network environment according to any radio access technology or technologies, either presently existing or developed in the future.

By implementing the quality evaluation device 10 as described herein, various advantages can be realized that can improve the performance of a communication network. These advantages can include, but are not limited to, the following. The quality evaluation device 10 can assess user QoE by using key performance indicators (KPIs) directly in the RAN 20, resulting in more accurate and meaningful quality evaluation at the RAN level. The range of applications and network use cases for which QoE data is generated and used can be increased. The ability to improve and optimize network performance can be increased. User QoE evaluation can be performed on the basis of an amount of data transmitted via a RAN 20 that would be impractical or impossible for a human to process in a useful or reasonable timeframe. Other advantages are also possible.

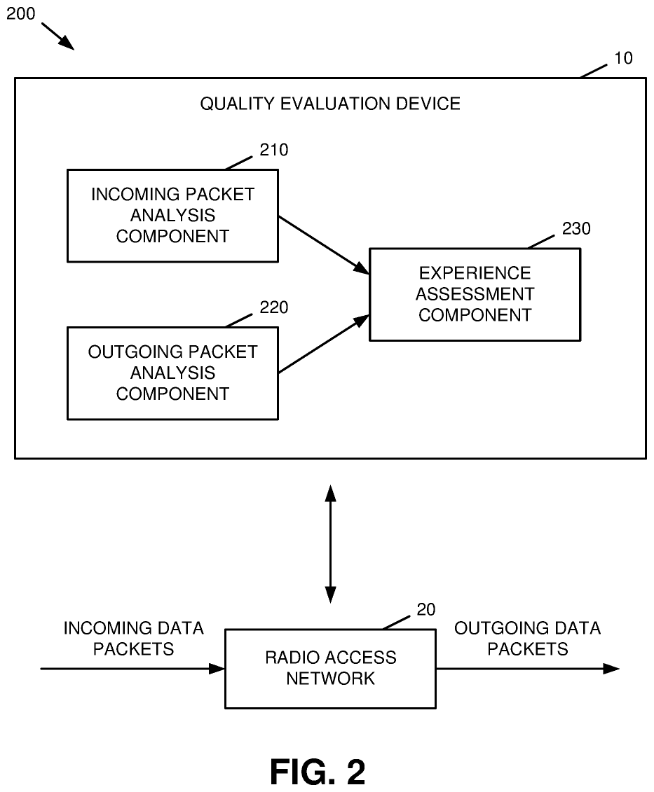

With reference now to FIG. 2, a block diagram of a system 200 that facilitates user quality of experience assessment in radio access networks is illustrated. Repetitive description of like elements employed in other embodiments described herein is omitted for brevity. System 200 as shown in FIG. 2 includes a quality evaluation device 10 that can operate in a similar manner to that described above with respect to FIG. 1. As shown in FIG. 2, the quality evaluation device 10 of system 200 includes an incoming packet analysis component 210 that can measure and/or otherwise determine an average packet size (e.g., in bits and/or any other suitable unit of measurement) of incoming data packets received via the RAN 20. In an aspect, the incoming data packets can be IP packets that respectively include data directed to respective network equipment (e.g., network equipment 30 as shown in FIG. 1) served via the RAN 20.

As further shown in FIG. 2, the quality evaluation device 10 of system 200 additionally includes an outgoing packet analysis component 220 that can determine service metrics or other key performance indicators (KPIs) for outgoing data packets transmitted via the RAN 20, e.g., in response to the incoming data packets described above being received via the RAN 20. In an aspect, the service metrics that can be determined by the outgoing packet analysis component 220 can include an average transmission delay for the outgoing data packets, a packet loss rate for the outgoing data packets, and/or any other suitable metric(s).

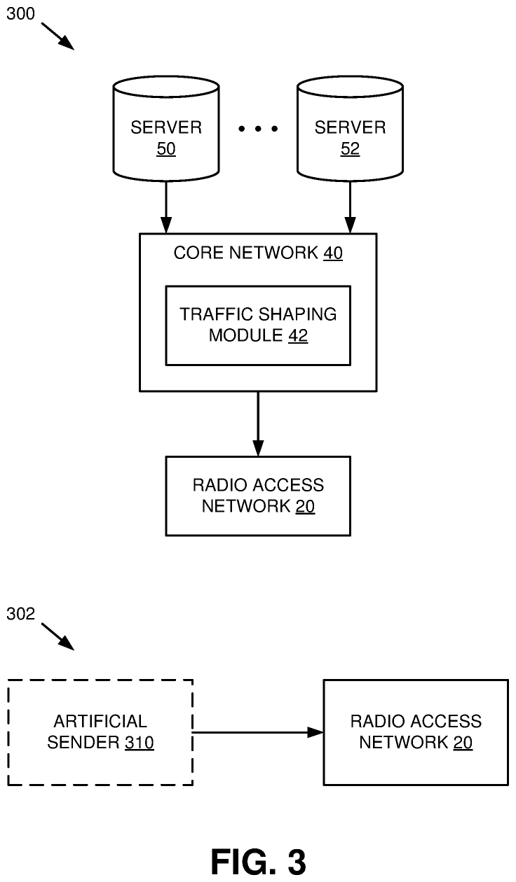

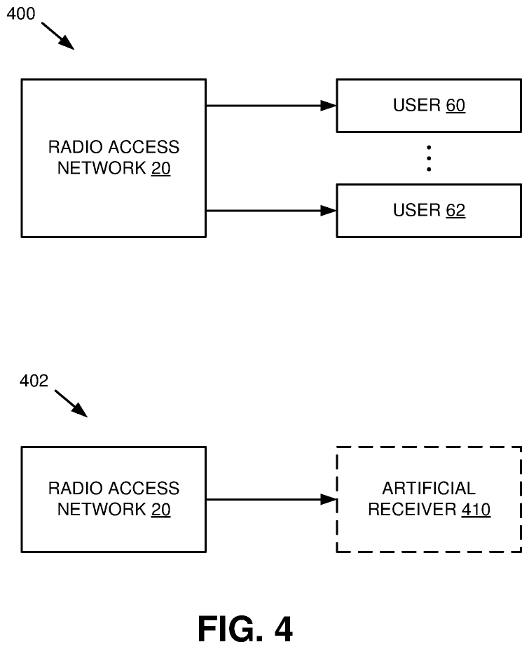

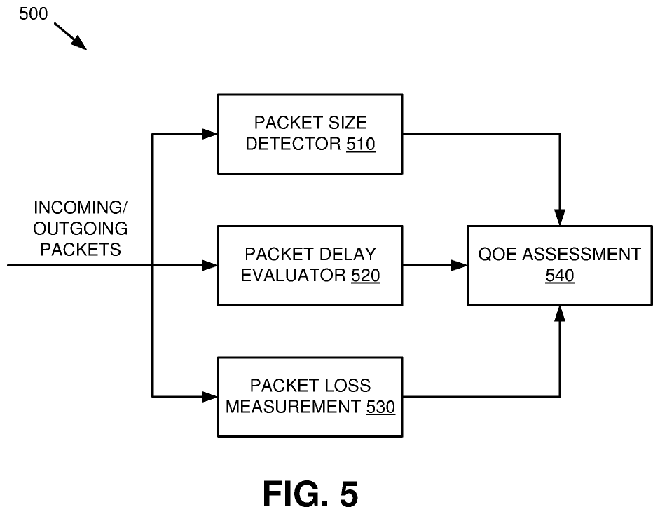

The quality evaluation device 10 of system 200 further includes an experience assessment component 230 that can quantify the performance of the RAN 20 by determining a quality of experience (QoE) value or score to the RAN 20 based on a function of the average packet size of the incoming data packets as measured by the incoming packet analysis component 210 and the service metrics (e.g., transmission delay, packet loss rate, etc.) determined by the outgoing packet analysis component 220. In an aspect, the experience assessment component 230 can evaluate the user QoE associated with the RAN 20 using RAN KPIs directly, which in turn can enable the quality evaluation device 10 to decouple the RAN 20 from other network elements in communication with the RAN 20. Example abstractions that can be performed by the quality evaluation device 10 for non-RAN network elements in this manner are described in further detail below with respect to FIGS. 3-4. Additionally, example computations that can be performed by the experience assessment component 230 to determine user QoE for the RAN 20 are described in further detail below with respect to FIG. 5.

Modern wireless networks, such as LTE and 5G networks, are configured as all-Internet Protocol (IP) networks in which standard communications protocols, such as Transmission Control Protocol/Internet Protocol (TCP/IP), to send and receive data in packets. This can enable a network to handle various services and applications such as file downloads, web browsing, gaming, video streaming, IoT device communications, or the like. Each service and/or application supported by an IP network can have its own characteristics, e.g., such that measurement of service quality metrics can vary from one service or application to another. For instance, a video streaming application can utilize metrics such as stalls, rebuffering rate, etc., to assess user QoE, while other applications or services, such as IoT device communication, can use different metrics. Accordingly, user QoE evaluation can involve tracking a large amount of metrics across all services and applications of a communication network. Further, as the amount of services and applications enabled via communication networks increases, the amount of tracked metrics could similarly increase.

In addition to the above, QoE assessment at the RAN level can be complicated due to data traffic being undifferentiated at the RAN. More particularly, the RAN functionally operates as a large data conduit in which different services are undifferentiated, resulting in all packets at the RAN being treated as a single pipeline of similar data packets. Accordingly, QoE assessment operations can in some cases involve tracing respective packets back to their source(s), such as a core network in communication with the RAN. These trace back operations can introduce significant amounts of computational cost and complexity to the QoE assessment process.

In view of the above, the quality evaluation device 10 of system 200 can operate as described herein to assess the QoE at the RAN 20 based on information available at the RAN 20 alone, e.g., without tracing back to other network elements in communication with the RAN 20. Because data traffic associated with the RAN 20 is composed of small packets, and these packets are delayed or discarded based on the performance of the RAN 20, the quality evaluation device 10 can use unified metrics for QoE assessment.

Since the RAN 20 does not distinguish between types of traffic, a generalized measure of RAN user throughput can be derived from respective counters associated with the RAN 20, namely counters collecting the total number of bits transmitted by all users and counters collecting the total amount of time used for transmitting these bits, including the user waiting time in which data is buffered awaiting transmission. Based on this information, the average user throughput (Tput) can be calculated as the traffic weighted harmonic mean throughput for all users, which can be expressed as follows:

$$Tput = \frac{overall traffic}{overall time} = \frac{\sum {J}_{i}}{\sum \frac{{J}_{i}}{{T}_{i}}} ,$$

where Jᵢ and Tᵢ are the traffic and throughput for user i, respectively.

While average user throughput can reliably capture aggregated user performance, this metric has limitations for various types of traffic. As an example, a data source can operate such that bursts of IP packets arrive every 100 ms and each burst has ten packets that are 1046 bytes each in size. Assuming the RAN capacity is sufficiently large to not constrain transmission speed, the user throughput in this example can be expressed as follows:

$$Tput = \frac{10 packets}{1 ms} = \frac{10 \times 1460 bytes}{1 ms} = 116.8 Mbps .$$

However, if the packets instead arrive at the RAN 20 at the same data rate but a higher burst frequency, e.g., where bursts of IP packets arrive every 10 ms and each burst has only one packet, the user throughput can be expressed as follows:

$$Tput = \frac{1 packet}{1 ms} = \frac{1460 bytes}{1 ms} = 11.68 Mbps .$$

In the above examples, the measured user throughputs are different solely due to differences in the pattern of incoming traffic, even though the incoming data rate remains the same and user QoE is not impacted.

In an aspect, the quality evaluation device 10 of system 200 can facilitate improved user performance evaluation by using metrics that are both representative of real user performance and derivable from the RAN 20 without tracing back to respective traffic sources. Stated another way, the quality evaluation device 10 can evaluate user QoE via techniques that decouple the RAN 20 from its associated sources.

By way of example, diagram 300 in FIG. 3 illustrates data sources that can provide data packets to the RAN 20. As shown in diagram 300, respective content servers 50, 52 can send packets directed to one or more devices served by the RAN 20. As noted above, the packets sent from the content servers 50, 52 could differ depending on the service(s) associated with the content servers 50, 52 and the respective packets. As additionally shown by diagram 300, packets originating from the content servers 50, 52 can be provided to elements of the RAN 20 via a core network 40, which can include one or more traffic shaping modules 42 that can shape the packets, e.g., such that they arrive at the RAN 20 with a changed pattern relative to an initial state of the packets.

As data from a source (e.g., a content server 50, 52) can travel through multiple modules of the network before arriving at the RAN 20, each of which could alter the pattern of the packets as transmitted from their source, tracing back the packets from the RAN 20 through each of these modules can be prohibitively complex. In order to mitigate this complexity, the quality evaluation device 10 of system 200 can treat all arriving packets to the RAN 20 as originating from a single artificial sender 310, as shown in diagram 302 of FIG. 3. As such, the incoming packet analysis component 210 of the quality evaluation device 10 can measure average packet sizes of incoming data packets, and/or other suitable metrics, irrespective of the sources of the respective incoming data packets.

In an aspect, similar abstractions can be performed for outgoing packets from the RAN 20, as shown by diagrams 400 and 402 in FIG. 4. As shown by diagram 400, the RAN 20 can transmit outgoing data packets to multiple users 60, 62, each of which can have their own individual properties. As shown by diagram 402, the quality evaluation device 10 can perform a similar abstraction to that shown in diagram 302 by treating all destinations of packets transmitted via the RAN 20 as a single artificial receiver 410. As a result, the outgoing packet analysis component 220 can determine service metrics for outgoing data packets, such as transmission delay, packet loss rate, and/or other suitable metrics, irrespective of the destinations of the respective outgoing data packets.

In an all-IP network, IP packets are the atomic transmission unit entering the RAN 20. Additionally, with the limited exception of Voice over IP (VoIP) service, the RAN 20 generally does not distinguish between packets of different services. Accordingly, the quality evaluation device 10 of system 200 can operate as described herein to derive user QoE from measurements performed on packets.

Referring now to FIG. 5, and with further reference to FIG. 2, a system 500 for assessing QoE associated with a communication network on the basis of incoming and outgoing packets associated with the communication network is illustrated. In an aspect, system 500 as described below can be utilized by the quality evaluation device 10 and its respective components 210, 220, 230 for evaluating user QoE associated with a RAN (e.g., RAN 20) and/or other communication networks.

System 500 as shown in FIG. 5 includes a packet size detector 510, a packet delay evaluator 520, and a packet loss measurement module 530, each of which can analyze incoming and/or outgoing packets associated with a given RAN to generate respective key performance indicators (KPIs) associated with the performance of the RAN. System 500 as shown in FIG. 5 further includes a QoE assessment module 540 that can estimate user QoE based on the KPIs generated from modules 510, 520, 530. Similar to the above description, system 500 can decouple the application layer from lower layers by abstracting the network components beyond the RAN as one artificial TCP sender and abstracting all associated users as one artificial receiver. By doing so, system 500 can disregard the various modules in the network that could change the pattern of the incoming packets and instead treat all transactions through the RAN as a single TCP connection, enabling the QoE assessment module 540 to estimate user QoE based on determined RAN KPIs without the use of higher layer statistics.

The respective modules 510, 520, 530, 540 shown in system 500 can operate, at least in part, using counters or other mechanisms for obtaining statistics from respective packets over the course of a defined time window. For example, modules 510, 520, 530 can generate RAN KPIs based on packets received and/or transmitted via the RAN within defined time intervals (e.g., 15 minute intervals, etc.), and the QoE assessment module 540 can utilize the RAN KPIs to estimate user QoE over the same intervals. In some implementations, time intervals utilized by the respective modules 510, 520, 530, 540 of system 500 can be the same time intervals or different time intervals (e.g., intervals of different periods, intervals offset in time relative to each other, etc.). In other implementations, consecutive intervals of a given period can be combined to form composite intervals of a longer period, which can be utilized for cases in which larger sample sizes are desired for QoE assessment.

The packet size detector 510 of system 500 can measure the average size of data packets associated with a RAN over a given time interval based on the total number of bits in the packets received over the time interval divided by the number of packets received in the time interval, e.g.,

$$packet size = \frac{\# bits in all packets}{\# all packets received} .$$

The packet delay evaluator 520 of system 500 can determine an average RAN delay for all packets observed in a given time interval, e.g., the time intervals described above. In an aspect, a delay determined by the packet delay evaluator 520 for a given packet can be indicative of outgoing packet delay, e.g., the delay between an incoming packet arriving at the RAN and a corresponding outgoing packet departing the RAN, which can be expressed as follows:

packet delay=t_{depart}−t_{entry}.

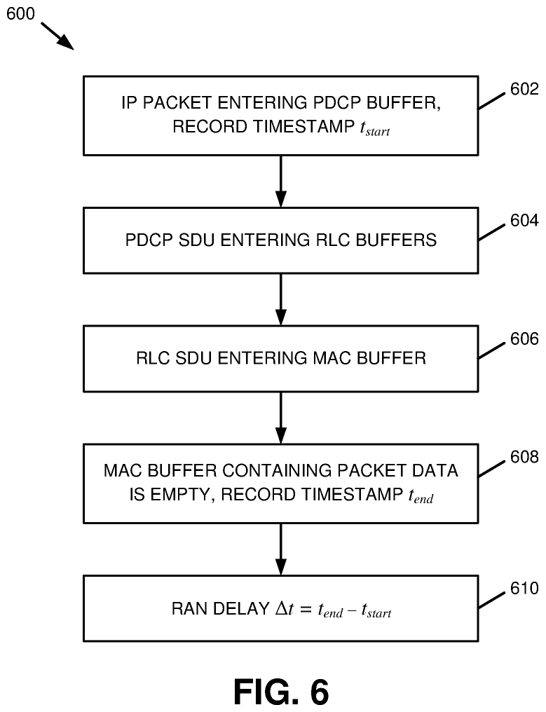

In another aspect, the packet delay evaluator 520 can determine the packet transmission delay for a given outgoing packet as a function of a first time at which an outgoing data packet arrives at a Packet Data Convergence Protocol (PDCP) buffer at the RAN, as well as a second time at which the outgoing data packet departs from a Media Access Control (MAC) buffer at the RAN. This process is shown in further detail by method 600 in FIG. 6. As shown by FIG. 6, method 600 can begin at 602, in which a timestamp tₛₜₐᵣₜ can be recorded in response to an IP packet entering the PDCP buffer of the RAN.

After recording the timestamp tₛₜₐᵣₜ at 602, a PDCP Service Data Unit (SDU) corresponding to the IP packet can be tracked through its entry into the Radio Link Control (RLC) buffers of the RAN at 604. Next, at 606, the resulting RLC SDU can be tracked through entry of the MAC buffer at the RAN.

At 608, in response to the MAC buffer containing the packet data tracked at 602-606 becoming empty, a second timestamp t_{end} can be recorded. Method 600 can then conclude at 610, in which the RAN delay Δt associated with the IP packet can be calculated as the difference between the timestamps recorded at 608 and 602, respectively, e.g.,

Δt=t_{end}−tₛₜₐᵣₜ.

Returning to FIG. 5, the packet loss measurement module 530 of system 500 can compute the average packet loss rate for all transactions in a given time interval, such as the time intervals described above. In an aspect, the packet loss rate determined by the packet loss measurement module 530 can be used to supplement the RAN delay data determined by the packet delay evaluator 520, particularly in implementations in which outgoing packets are discarded by the RAN if not transmitted within a given timeout interval.

In an implementation, a packet loss rate can be determined by the packet loss measurement module 530 as the ratio of discarded packets over a given time interval to the total number of packets received in that time interval. Alternatively, the packet loss rate can be determined from the number of packets successfully transmitted and the number of packets received as follows:

$$packet loss rate = 1 - \frac{\# packets successfully transmitted}{\# packets received}$$

The QoE assessment module 540 of system 500 can determine a user QoE associated with the RAN as a function of the respective service metrics determined by the packet size detector 510, the packet delay evaluator 520, and the packet loss measurement module 530 as described above, e.g.,

QoE metric=f(packet size, packet delay, packet loss rate).

By combining the service metrics generated by the packet size detector 510, the packet delay evaluator 520, and the packet loss measurement module 530 into a single QoE metric, the QoE assessment module 540 can facilitate the generation of meaningful QoE metrics even in cases in which the input service metrics appear to be inconsistent.

In an aspect, the formula used by the QoE assessment module 540 can be any formula that is suitable for obtaining a unified metric from respective input metrics, such as the metrics described above. Also or alternatively, one or more constraints, such as upper or lower limits, can be placed on the QoE value determined by the QoE assessment module 540 as appropriate. By way of specific, non-limiting example, one formula that can be utilized by the QoE assessment module 540 is as follows:

$$QoE = min \{ \frac{S}{R \times \sqrt{p}} , \frac{{W}_{max}}{R} \} ,$$

Where S is the packet size in bits, R is the RAN delay in milliseconds, p is the packet loss rate, and Wₘₐₓ is the maximum window for the TCP transmitter of the RAN, which can be associated with a default value of 65535 bytes×8=524280 bits, and/or any other appropriate value. In an aspect, the latter term in the above equation can serve as an upper limit to the QoE value since the former term approaches infinity as the packet loss rate approaches zero.

In the formula given above, the QoE metric calculated by the QoE assessment module 540 is inversely impacted by RAN delay and packet loss but directly benefits from larger packet sizes. It is noted, however, that other formulas, such as other TCP throughput formulas, could also be used in addition to, or in place of, the formula given above. Additionally, the Wₘₐₓ parameter in the above equation could be substituted with any other suitable constant or variable value(s). For instance, the specific formula used by the QoE assessment module 540 could in some cases vary based on the properties of a given network and/or based on other factors.

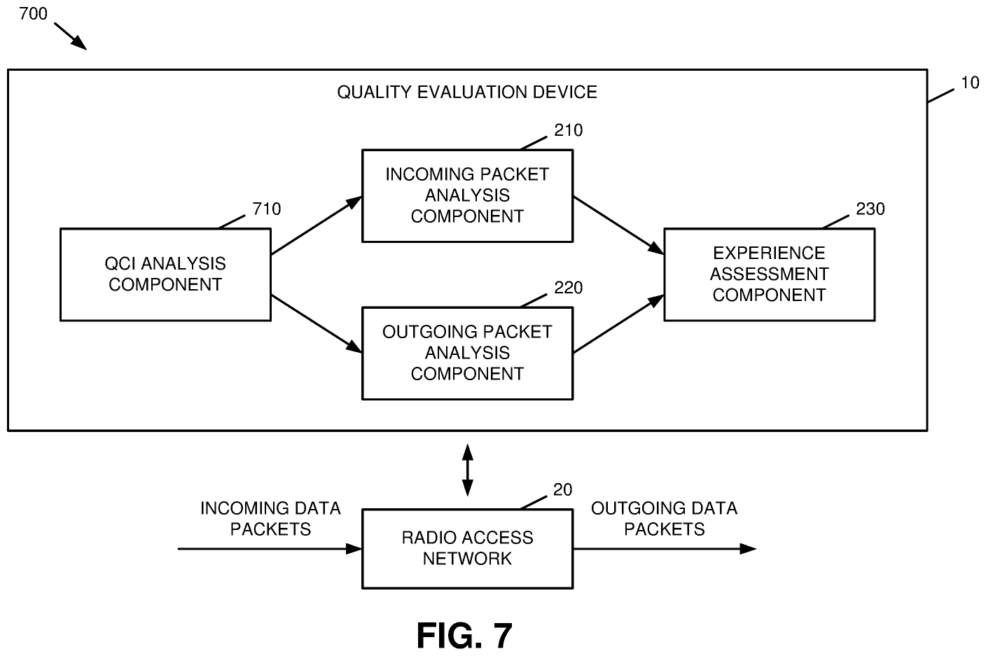

Turning next to FIG. 7, a block diagram of a system 700 that facilitates user quality of experience assessment for select devices served via a RAN 20 is illustrated. Repetitive description of like elements employed in other embodiments described herein is omitted for brevity. System 700 as shown in FIG. 7 includes a quality evaluation device 10, which in turn includes a Quality Class Indicator (QCI) analysis component 710 that can facilitate per-QCI class packet analysis (e.g., by the incoming packet analysis component 210 and/or outgoing packet analysis component 220) and QoE assessment (e.g., by the experience assessment component 230).

While the example implementation shown in FIG. 7 is specific to per-QCI class analysis, it is noted that the quality evaluation device 10 of system 700 could similarly perform analysis across other subsets of an associated communication network. For example, for communication networks in which network slicing is enabled, such as 5G networks or the like, the quality evaluation device 10 of system 700 could perform analysis across respective network slices in a similar manner to the per-QCI analysis described below. Other implementations are also possible.

In an aspect, the QCI analysis component 710 of the quality evaluation device 10 shown in system 700 can monitor incoming data packets received via the associated RAN 20 in order to determine QCI classifications associated with the incoming data packets, e.g., QCI values assigned to the respective incoming data packets from among a group of QCI values. The QCI analysis component 710 can then facilitate metric generation and QoE assessment for a specific QCI class by selecting respective ones of the incoming data packets for further processing (e.g., by the incoming packet analysis component 210, outgoing packet analysis component 220, and/or experience assessment component 230) that are associated with a target QCI of the group of QCI values.

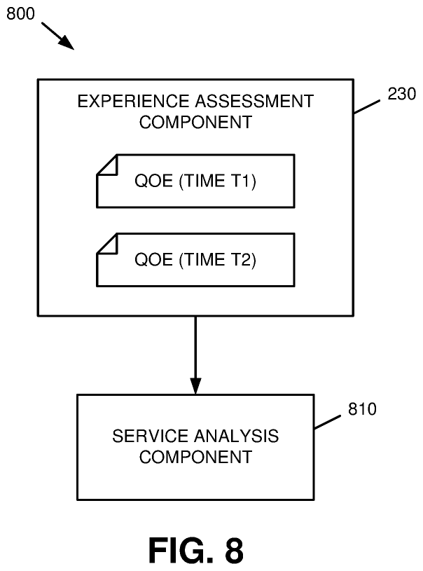

Referring now to FIG. 8, a block diagram of a system 800 that facilitates performance assessment for a service added to a RAN 20 is illustrated. Repetitive description of like elements employed in other embodiments described herein is omitted for brevity. System 800 as shown in FIG. 8 includes an experience assessment component 230 that can determine user QoE values for an associated RAN, e.g., as described above with respect to FIGS. 2 and 5. As further shown in system 800, the experience assessment component 230 can determine a first QoE value for an associated RAN at a time T1 and a second QoE value for the RAN at a later time T2.

In an implementation, time T1 as used by the experience assessment component 230 shown in system 800 can correspond to a time prior to adding a service, tool, or other feature to the associated RAN, while time T2 can correspond to a time subsequent to adding the service, tool, or other feature. Based on these QoE values, system 800 further includes a service analysis component 810 that can quantify the performance of the added service, tool, or other feature based on a result of comparing the QoE values determined at times T1 and T2.

In an aspect, the service analysis component 810 can determine a net QoE change between times T1 and T2 based on a difference of the provided QoE values, e.g., ΔQoE=QoE_{T2}−QoE_{T1}. Based on the net QoE change, the service analysis component 810 can estimate an impact of changes made to the RAN between times T1 and T2. For instance, a positive net QoE change can be indicative of improvements to the performance of the RAN, e.g., due to the implementation of new performance optimization tools or the like, while a negative net QoE change can be indicative of adverse performance impact on the RAN associated with the addition of new services. It is noted, however, that other methods for comparing QoE values, as well as other inferences that can be derived from such a comparison, could also be used.

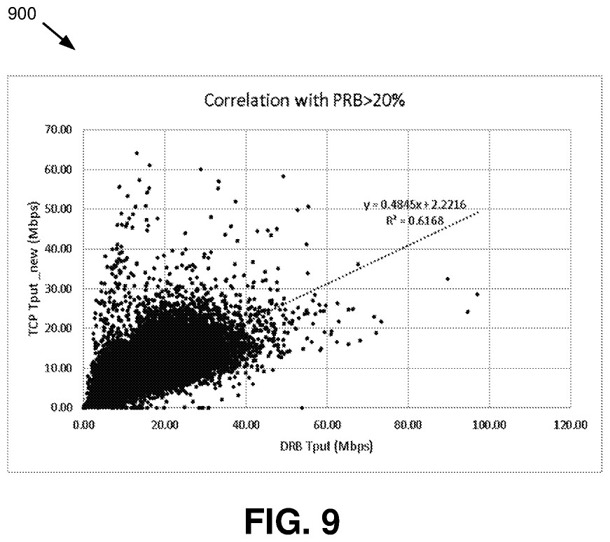

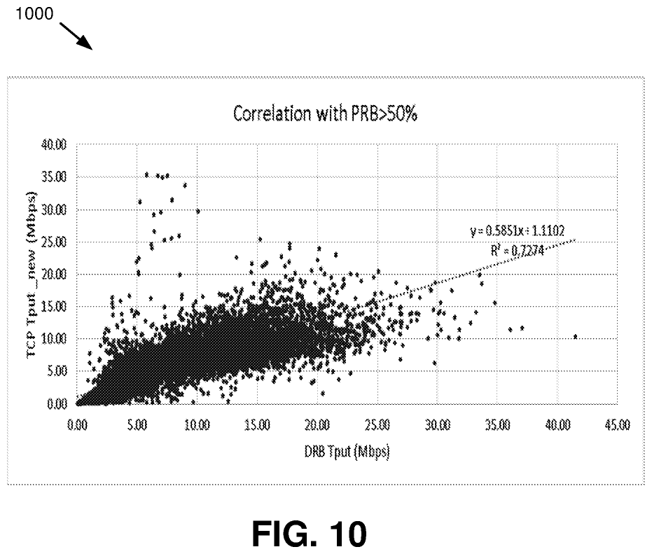

Turning now to FIGS. 9-10, respective diagrams 900, 1000 are illustrated that depict correlations between user QoE as assessed by various aspects described herein and user throughput for an example RAN. In diagrams 900 and 1000, user QoE is labeled as TCP Tput_new, and user throughput is given as Data Radio Bearer (DRB) throughput. Diagram 900 in FIG. 9 illustrates a correlation for an example RAN under relatively low congestion, e.g., such that Physical Resource Block (PRB) usage is approximately 20 percent, while diagram 1000 in FIG. 10 illustrates a similar correlation for an example RAN under higher congestion, e.g., such that the PRB usage is approximately 50 percent.

As shown in diagrams 900 and 1000, an observable correlation exists between the user QoE metric determined as described herein and the traditional throughput metric. Based on a comparison of diagrams 900 and 1000, a better correlation is observed with highly loaded cells, e.g., due to the difference between user QoE and user throughput occurring primarily in cases in which traffic amounts are smaller. As user throughput is relatively more representative of RAN capacity while user QoE is relatively more representative of user experience, the two metrics can complement each other for RAN quality analysis.

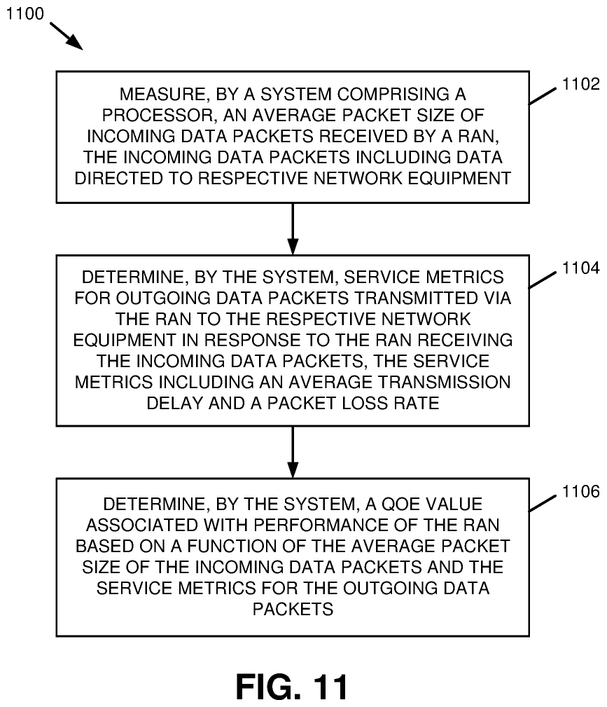

With reference to FIG. 11, a flow diagram of a method 1100 that facilitates user quality of experience assessment in radio access networks is presented. At 1102, a system comprising a processor (e.g., a quality evaluation device 10 comprising a processor 14, and/or a system including such a device) can measure (e.g., by an incoming packet analysis component 210 and/or other components implemented by the processor 14) an average packet size of incoming data packets received by a RAN (e.g., RAN 20). In an aspect, the incoming data packets can include data that are directed to respective network equipment (e.g., network equipment 30) served via the RAN.

At 1104, the system can determine (e.g., by an outgoing packet analysis component 220 and/or other components implemented by the processor 14) service metrics for outgoing data packets transmitted via the RAN to the respective network equipment in response to the incoming data packets analyzed at 1102 being received via the RAN. The service metrics determined at 1104 can include an average transmission delay associated with the outgoing data packets, a packet loss rate associated with the outgoing data packets, and/or other metrics.

At 1106, the system can determine (e.g., by an experience assessment component 230 and/or other components implemented by the processor 14) a QoE value associated with the performance of the RAN based on a function of the average packet size of the incoming data packets as measured at 1102 and the service metrics for the outgoing data packets as determined at 1104.

FIGS. 6 and 11 illustrate methods in accordance with certain aspects of this disclosure. While, for purposes of simplicity of explanation, the methods are shown and described as a series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain aspects of this disclosure.

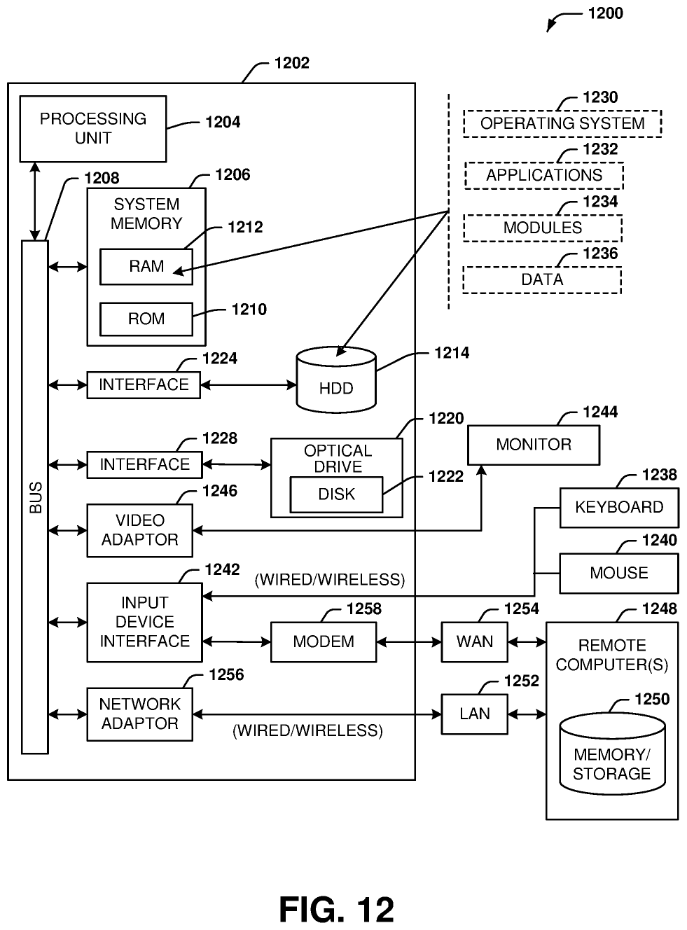

In order to provide additional context for various embodiments described herein, FIG. 12 and the following discussion are intended to provide a brief, general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 and an optical disk drive 1220, (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214 and optical disk drive 1220 can be connected to the system bus 1208 by an HDD interface 1224 and an optical drive interface 1228, respectively. The HDD interface 1224 can additionally support external drive implementations via Universal Serial Bus (USB), Institute of Electrical and Electronics Engineers (IEEE) 1394, and/or other interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) can include a microphone, an infrared (IR) remote control, a joystick, a game pad, a stylus pen, touch screen or the like. These and other input devices are often connected to the processing unit 1204 through an input device interface 1242 that can be coupled to the system bus 1208, but can be connected by other interfaces, such as a parallel port, an IEEE 1394 serial port, a game port, a USB port, an IR interface, a BLUETOOTH® interface, etc.

A monitor 1244 or other type of display device can be also connected to the system bus 1208 via an interface, such as a video adapter 1246. In addition to the monitor 1244, a computer typically includes other peripheral output devices (not shown), such as speakers, printers, etc.

The computer 1202 can operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1252 through a wired and/or wireless communication network interface or adapter 1256. The adapter 1256 can facilitate wired or wireless communication to the LAN 1252, which can also include a wireless access point (AP) disposed thereon for communicating with the wireless adapter 1256.

When used in a WAN networking environment, the computer 1202 can include a modem 1258 or can be connected to a communications server on the WAN 1254 or has other means for establishing communications over the WAN 1254, such as by way of the Internet. The modem 1258, which can be internal or external and a wired or wireless device, can be connected to the system bus 1208 via the input device interface 1242. In a networked environment, program modules depicted relative to the computer 1202 or portions thereof, can be stored in the remote memory/storage device 1250. It will be appreciated that the network connections shown are example and other means of establishing a communications link between the computers can be used.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
measuring, by a system comprising a processor, an average packet size of incoming data packets received via a radio access network, the incoming data packets respectively comprising data directed to respective network equipment served via the radio access network;
determining, by the system, service metrics for outgoing data packets transmitted via the radio access network to the respective network equipment in response to the incoming data packets being received via the radio access network, wherein the service metrics comprise an average transmission delay for the outgoing data packets and a packet loss rate for the outgoing data packets; and
determining, by the system, a quality of experience value associated with a performance of the radio access network based on a function of the average packet size of the incoming data packets and the service metrics for the outgoing data packets.

2. The method of claim 1, wherein the incoming data packets are first incoming data packets, and wherein the method further comprises:
monitoring, by the system, second incoming data packets received via the radio access network, wherein the second incoming data packets are associated with respective indicators of a group of quality class indicators; and
selecting, by the system as the first incoming data packets, respective data packets of the second incoming data packets that are associated with a target quality class indicator of the group of quality class indicators.

3. The method of claim 1, wherein the function is a first function, and wherein determining the quality of experience value comprises defining an upper limit for the quality of experience value as a second function of a transmission control protocol window size associated with the radio access network.

4. The method of claim 1, wherein the quality of experience value is a first quality of experience value, wherein determining the first quality of experience value comprises determining the first quality of experience value at a first time that is prior to addition of a communication service to the radio access network, and wherein the method further comprises:
determining, by the system, a second quality of experience value associated with the performance of the radio access network at a second time that is subsequent to the addition of the communication service to the radio access network.

5. The method of claim 4, wherein the performance of the radio access network is a first performance, and further comprising:
quantifying, by the system, a second performance of the communication service based on a result of comparing the first quality of experience value and the second quality of experience value.

6. The method of claim 1, wherein measuring the average packet size of the incoming data packets comprises measuring the average packet size of the incoming data packets irrespective of sources of the incoming data packets.

7. The method of claim 1, wherein determining the service metrics for the outgoing data packets comprises determining the service metrics for the outgoing data packets irrespective of destinations of the outgoing data packets.

8. The method of claim 1, wherein determining the service metrics for the outgoing data packets comprises determining respective transmission delays for the outgoing data packets as a function of first times, at which the outgoing data packets arrive at a packet data convergence protocol buffer at the radio access network, and second times, at which the outgoing data packets depart from a media access control buffer at the radio access network.

9. A system, comprising:
a processor; and
a memory that stores executable instructions that, when executed by the processor, facilitate performance of operations, comprising:
determining an average packet size for incoming data packets received via a radio access network, wherein the incoming data packets respectively comprise data directed to network devices served via the radio access network;
determining service quality metrics for outgoing data packets, transmitted via the radio access network to the respective network equipment in response to reception of the incoming data packets via the radio access network, the service quality metrics comprising an average transmission delay for the outgoing data packets and a packet loss rate for the outgoing data packets; and
assigning a quality of experience score, indicative of a performance of the radio access network, to the radio access network based on a function of the average packet size for the incoming data packets and the service quality metrics for the outgoing data packets.

10. The system of claim 9, wherein the incoming data packets are first incoming data packets, and wherein the operations further comprise:
monitoring quality class indicators assigned to respective second incoming data packets received via the radio access network, wherein the quality class indicators comprise a target quality class indicator and at least one non-target quality class indicator; and
selecting, as the first incoming data packets, respective ones of the second incoming data packets that are assigned to the target quality class indicator.

11. The system of claim 9, wherein the function is a first function, and wherein the operations further comprise:
defining an upper limit for the quality of experience score as a second function of a transmission control protocol window size associated with the radio access network.

12. The system of claim 9, wherein the quality of experience score is a first quality of experience score indicative of a first performance of the radio access network at a first time that is prior to addition of a communication service to the radio access network, and wherein the operations further comprise:
assigning a second quality of experience score, indicative of a second performance of the radio access network at a second time that is subsequent to the addition of the communication service to the radio access network, to the radio access network.

13. The system of claim 12, wherein the operations further comprise:
quantifying a third performance of the communication service based on a result of comparing the first quality of experience score and the second quality of experience score.

14. The system of claim 9, wherein determining the average packet size for the incoming data packets comprises determining the average packet size for the incoming data packets irrespective of sources of the incoming data packets.

15. The system of claim 9, wherein determining the service quality metrics for the outgoing data packets comprises determining the service quality metrics for the outgoing data packets irrespective of destinations of the outgoing data packets.

16. A non-transitory machine-readable medium, comprising executable instructions that, when executed by a processor, facilitate performance of operations, comprising:
measuring an average size of incoming data packets, received via a radio access network and comprising data directed to network equipment served via the radio access network;
determining service quality metrics for outgoing data packets, transmitted via the radio access network to the respective network equipment in response to the radio access network receiving the incoming data packets, wherein the service quality metrics comprise an average transmission delay of the outgoing data packets and a packet loss rate for the outgoing data packets; and
quantifying a performance of the radio access network based on a function of the average size of the incoming data packets and the service quality metrics for the outgoing data packets.

17. The non-transitory machine-readable medium of claim 16, wherein the incoming data packets are first incoming data packets, and wherein the operations further comprise:
monitoring second incoming data packets, received via the radio access network and assigned to respective indicators of a group of quality class indicators; and
selecting, as the first incoming data packets, respective packets of the second incoming data packets that are associated with a target quality class indicator of the group of quality class indicators.

18. The non-transitory machine-readable medium of claim 16, wherein the operations further comprise:
determining a quality of experience value for the radio access network according to the function of the average size of the incoming data packets and the service quality metrics for the outgoing data packets.

19. The non-transitory machine-readable medium of claim 18, wherein the quality of experience value is a first quality of experience value, and wherein the operations further comprise:
determining the first quality of experience value at a first time that is prior to addition of a communication service to the radio access network; and
determining a second quality of experience value for the radio access network at a second time that is subsequent to the addition of the communication service to the radio access network.

20. The non-transitory machine-readable medium of claim 19, wherein the performance of the radio access network is a first performance, and wherein the operations further comprise:
quantifying a second performance of the communication service based on a result of comparing the first quality of experience value and the second quality of experience value.
